(19) United States
(12) Patent Application Publication
(10) Pub. No.: US 2018/0261052 A1
(43) Pub. Date: Sep. 13, 2018

(54) POINT-OF-SALE REGISTER MACHINE

(71) Applicant: TOSHIBA TEC KABUSHIKI KAISHA, Tokyo (JP)

(72) Inventor: Jun IWAMOTO, Sunto Shizuoka (JP)

(21) Appl. No.: 15/890,084

(22) Filed: Feb. 6, 2018

(30) Foreign Application Priority Data
Mar. 8, 2017 (JP) 2017-043458

(51) Int. Cl. G07G 1/00; G07G 1/06; G07G 1/12; G06Q 20/20

(52) U.S. Cl. CPC G07G 1/0009; G07G 1/0018; G06Q 20/20; G07G 1/12; G07G 1/06

(57) ABSTRACT

A register machine includes an input device configured to receive an input designating a language selection, and a control unit including a processor. The processor is configured to select an output target from among a plurality of output devices to which output information related to a sales transaction can be sent, set a language of the output information sent to the output target according to the designated language selection, and output the output information to the output target in the language that has been set.

### CROSS-REFERENCE TO RELATED APPLICATION

This application is based upon and claims the benefit of priority from Japanese Patent Application No. 2017-043458, filed Mar. 8, 2017, the entire contents of which are incorporated herein by reference.

### FIELD

Embodiments described herein relate generally to a point-of-sale register machine.

### BACKGROUND

In the related art, a sales data processing apparatus, such as a point of sale (POS) terminal, is used at retail stores such as a supermarket or a convenience store.

Recently, the number of foreigners visiting Japan for the purpose of shopping and sightseeing has been increasing. In addition, the number of foreigners coming to Japan for working has also been increasing. Therefore, it is desirable that the sales data processing apparatus be capable of displaying information in a language which can be read by a store clerk as well as a different language which might be read by a customer.

### DESCRIPTION OF THE DRAWINGS

FIG. 1 is an external perspective view illustrating an example of an external appearance of a POS terminal.

FIG. 2 is a block diagram illustrating an example of a hardware configuration of the POS terminal.

FIG. 3 is an explanatory diagram illustrating an example of a data configuration of a clerk master table.

FIG. 4 is an explanatory diagram illustrating an example of a data configuration of a customer master table.

FIG. 5 is an explanatory diagram illustrating an example of a data configuration of a character string master table.

FIG. 6 is an explanatory diagram illustrating an example of a data configuration of a commodity master table.

FIG. 7 is a block diagram illustrating a characteristic functional configuration of a POS terminal.

FIG. 8 is a flowchart illustrating an example of a sales data process.

### DETAILED DESCRIPTION

Embodiments provide a register machine in which transaction languages can be flexibly changed.

A register machine, according to an embodiment, includes an input device configured to receive an input designating a language selection, and a control unit including a processor. The processor is configured to select an output target from among a plurality of output devices to which output information related to a sales transaction can be sent, set a language of the output information sent to the output target according to the designated language selection, and output the output information to the output target in the language that has been set. Hereinafter, an example sales data processing apparatus and an example sales data processing method will be described in detail with reference to the accompanying drawings. The example embodiments described below are possible embodiments of a sales data processing apparatus and a sales data processing method according to an embodiment of the present disclosure; however, these examples do not limit the scope of the present disclosure. Various changes in configuration, specifications, and the like of sales data processing apparatus and method are possible. The sales data processing apparatus of the present disclosure is applied to a point of sale (POS) terminal installed at a store as a non-limiting example.

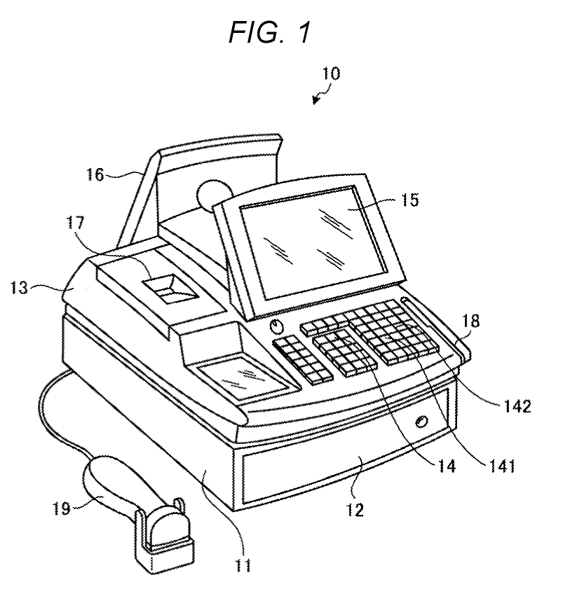

FIG. 1 is an external perspective view illustrating an example of an external appearance of a POS terminal 10. The POS terminal 10 is placed on a drawer unit 11, and can control an opening operation of a drawer 12 of the drawer unit 11. The drawer unit 11 stores cash received from the customer, cash used for change, or the like. The POS terminal 10 may include the drawer unit 11 or an automatic changer instead of the drawer unit 11. A main body housing 13 of the POS terminal 10 includes a keyboard 14 and a first display unit 15 on an upper right-side.

The keyboard 14 includes various keys for operating the POS terminal 10. For example, the keyboard 14 includes a closing key 141 and a current total key 142. The closing key 141 is a key for signaling completion of sales registration processing of a commodity as a sales target. The current total key 142 is a key for causing subtraction of the total sales amount of a commodity from an amount of money received from the customer. In addition, the POS terminal 10 discharges a receipt once the current total key 142 is pressed.

The first display unit 15 is a touch panel display. For example, the first display unit 15 displays a screen mainly seen by an operator such as a store clerk. The main body housing 13 is provided with a second display unit 16 on a rear upper side. For example, the second display unit 16 is a touch panel display. For example, the second display unit 16 displays a screen mainly seen by the customer.

In the POS terminal 10, a printing unit 17 is provided on an upper left side of the main body housing 13. The printing unit 17 is a printer that prints the receipt, a transaction journal, and the like on paper. In addition, the paper may be in a roll form or may be sheets of paper.

In the POS terminal 10, a card reader-writer 18 is provided on a right-side surface of the main body housing 13. The card reader-writer 18 reads information from a credit card or the like for payment processing.

In addition, a hand-held scanner device 19 is provided with the POS terminal 10. The scanner device 19 is used to identify the items being sold in the sales transaction as according to an external appearance of the items and/or a code symbol attached to the item.

Next, a hardware configuration of the POS terminal 10 will be described.

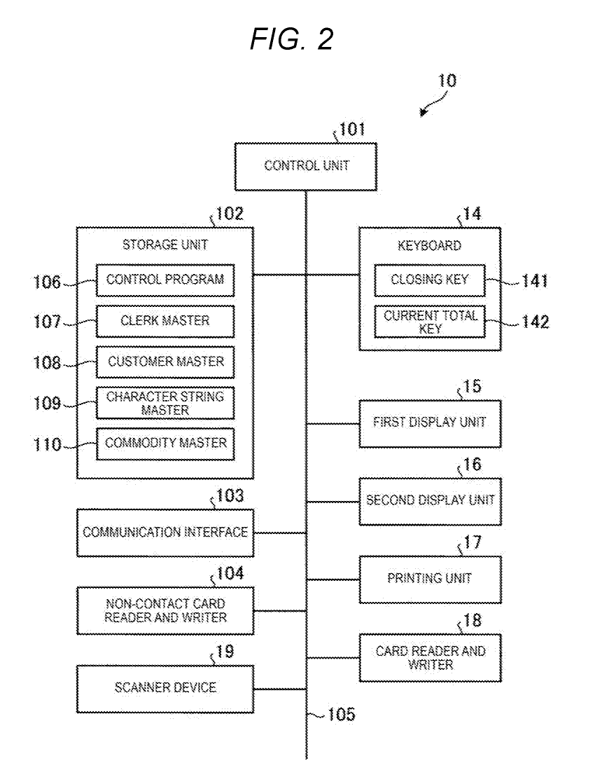

FIG. 2 is a block diagram illustrating an example of a hardware configuration of the POS terminal 10. The POS terminal includes a control unit 101, a storage unit 102, a communication interface 103, the scanner device 19, a keyboard 14, a first display unit 15, a second display unit 16, a printing unit 17, a card reader-writer 18, and a non-contact card reader-writer 104. The control unit 101, the storage unit 102, the communication interface 103, the scanner device 19, the keyboard 14, the first display unit 15, the second display unit 16, the printing unit 17, the card reader-writer 18, and the non-contact card reader -writer 104 are connected to each other through a system bus 105.

The control unit 101 is a computer that is configured to control the overall operation of the POS terminal 10 and to realize various operating functions of the POS terminal 10. The control unit 101 includes a central processing unit (CPU), a read-only memory (ROM), and a random access memory (RAM). The CPU controls operations of the POS terminal 10. The ROM is a storage medium for storing various programs and types of data. The RAM is a storage medium for temporarily storing various programs and working data during operations of the POS terminal 10. Here, the CPU executes a program initially stored in a ROM-type portion of the storage unit 102. RAM is provided as a work area (work region) for the CPU.

The storage unit 102 can be a storage device such as a hard disk drive (HDD) or a solid-state drive (SSD). The storage unit 102 stores a control program 106, a clerk master 107, a customer master 108, a character string master 109, and a commodity master 110. The clerk master 107, the customer master 108, the character string master 109, and the commodity master 110 may be stored in a storage device other than storage unit 102. For example, these tables maybe stored externally, such as on a store server.

The control program 106 is an operating system of the POS terminal 10. The control program 106 includes a program or program(s) for providing operating functions according to the present embodiment.

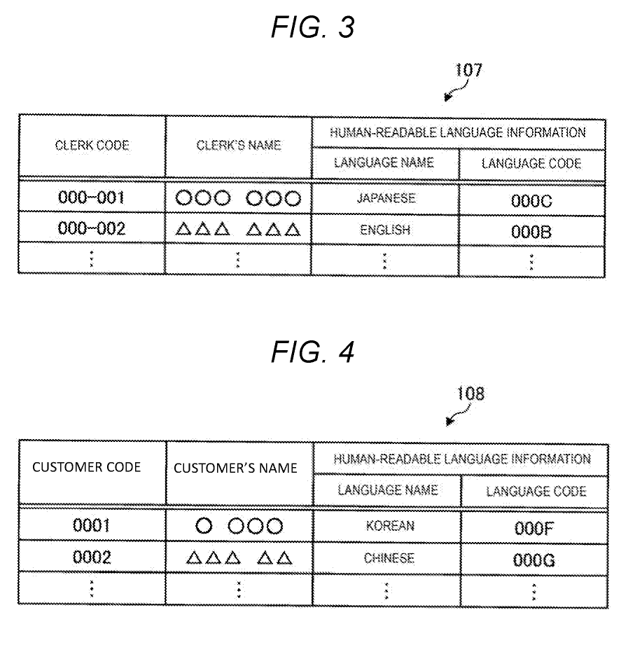

FIG. 3 is an explanatory diagram illustrating an example of the data configuration of the clerk master 107. The clerk master 107 is a database for storing various pieces of information relating to the clerk (s). The clerk master 107 associates a clerk code, with a clerk's name and the clerk's “human-readable language information.” The clerk code is identification information by which a clerk can be identified. The clerk's name is the name of the clerk. The human-readable language information is information indicating a language that can be read by the clerk. Here, the human-readable language information includes a language name and a language code. The language code is information by which the particular language can be identified. That is, in the human-readable language information, the language code indicates the language which can be read by the clerk.

FIG. 4 is an explanatory diagram illustrating an example of the data configuration of the customer master 108. The customer master 108 is a database for storing the various pieces of information relating to the customer. The customer master 108 associates a customer code, a customer's name, and human-readable language information. The customer code is the identification information by which a customer can be identified. The customer's name is the name of the customer. Similar to the clerk master 107, the human-readable language information is information indicating a language which can be read by the customer. Again the human-readable language information includes a language name and a language code.

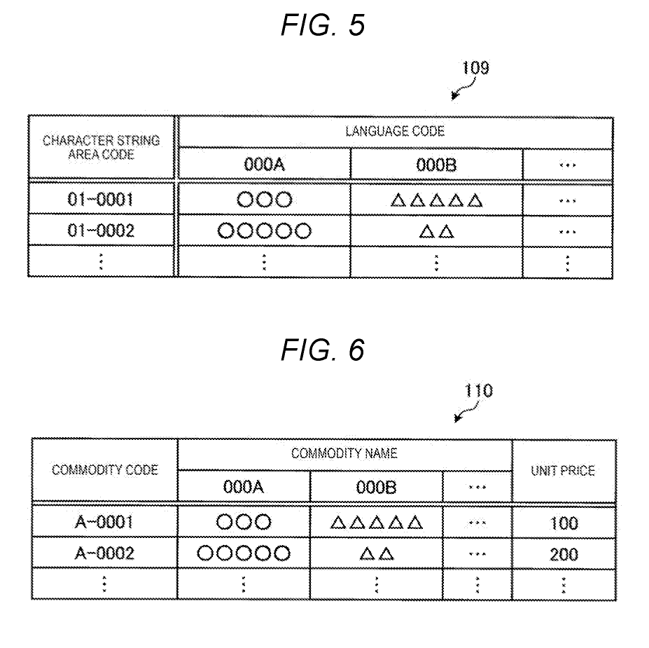

FIG. 5 is an explanatory diagram illustrating an example of the data configuration of the character string master 109. The character string master 109 is a database in which the possible character strings to be output for display, printing, and the like are stored for each available language (each language code). Here, the POS terminal 10 forms a display image or a print image by incorporating character strings from the character string master 109 into a template image. A character string area in the character string master 109 includes character strings defined for each type of displayable or printable image in the template images. Furthermore, content of the character strings included in the character string area can be defined for each type of the display image and print image. The character string master 109 stores a character string from each available language in association with each of the character string area codes. That is, the character string master 109 stores particular character strings from each language in association with each of the character string area codes.

FIG. 6 is an explanatory diagram illustrating an example of the data configuration of the commodity master 110. The commodity master 110 is a database for storing the various pieces of information relating to each commodity. The commodity master 110 associates a commodity code, a commodity name, and a unit price. The commodity code is identification information by which the commodity can be identified. The commodity name is the name of the commodity in each available language. The unit price is a price per unit quantity of the commodity.

Returning to FIG. 2, the communication interface 103 is an interface for connecting to a network.

The non-contact card reader-writer 104 performs reading and writing of information with respect to an IC tag of a non-contact IC card by a short-range wireless communication such as a near field communication (NFC).

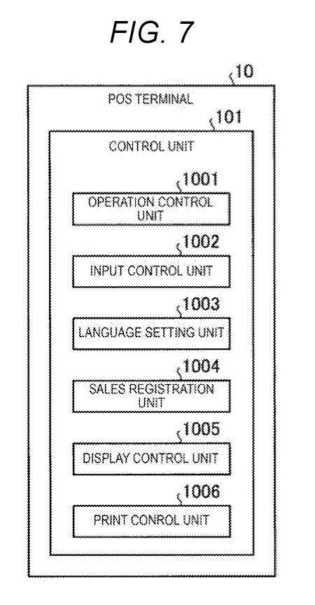

FIG. 7 is a block diagram illustrating a characteristic function configuration of the POS terminal 10. The CPU of the control unit 101 transfers the control program 106 to RAM and provides each operational unit illustrated in FIG. 7 in the RAM in accordance with the control program 106. Specifically, the control unit 101 includes an operation control unit 1001, an input control unit 1002, a language setting unit 1003, a sales registration unit 1004, a display control unit 1005, and a print control unit 1006, as functional units.

The operation control unit 1001 receives various inputs from the keyboard 14. For example, the operation control unit 1001 receives an input to signal the completion of the sales registration when the closing key 141 is pressed. In addition, the operation control unit 1001 subtracts the sales total from the amount of money received from the customer when the current total key 142 is pressed. In addition, the operation control unit 1001 is not limited to a keyboard 14, and may receive various inputs from a touch panel such as the touch panel of the first display unit 15 and/or the touch panel of the second display unit 16.

The input control unit 1002 is an example of an input unit. The input control unit 1002 receives an input for designating the language. For example, when the scanner device 19 reads a clerk code printed on an ID card of the clerk, the input control unit 1002 determines that there has been an input designating a language (a language code) associated with the clerk code in the clerk master 107. In addition, when the scanner device 19 reads a customer code printed on a membership card given to the customer, the input control unit 1002 determines that there has been an input designating a language (a language code) associated with the customer code in the customer master 108. The input control unit 1002 may also receive the clerk code and/or the customer code from the keyboard 14, the touch panel of the first display unit 15, or the touch panel of the second display unit 16.

The language setting unit 1003 is an example of a selection unit and a setting unit. The language setting unit 1003 sets a language used in display or printing. When there is the input for designating a language, the language setting unit 1003 selects an application range in which the designated language is applied. For example, the language setting unit 1003 selects whether the language displayed on the first display unit 15 or the second display unit 16 is changed. For example, according to the clerk language setting input, language displayed on the first display unit 15 and used in a journal indicating transaction details printed by the printing unit 17 is set to a language readable by the clerk. For the customer language setting input, the language used on the second display unit 16, the printed receipt, and the like can be set to a language readable by the customer.

When one of or both the clerk language setting and the customer language setting are changed, the language setting unit 1003 sets the language received by the input control unit 1002 within the selected application mode. More specifically, when the input control unit 1002 receives a clerk code, the language setting unit 1003 sets the language code associated with the clerk code in the clerk master 107 as the clerk language setting. When the input control unit 1002 receives a customer code, the language setting unit 1003 sets the language code associated with the customer code in the customer master 108 as the customer language setting. With this, the language setting unit 1003 controls the language that is used for the first display unit 15, the second display unit 16, the printing unit 17, or other components. The possible clerk language settings and the possible customer language settings may be arbitrarily varied. Furthermore, when the POS terminal 10 includes additional display units or the like, each of these additional display units or the like may controlled according selections output from language setting unit 1003. In addition, when a screen for the clerk and a screen for the customer are displayed on a single display unit, the language setting unit 1003 may select the language that is applied to each screen. When the input control unit 1002 does not receive an input for particularly selecting a language for the clerk language setting and/or the customer language setting, the language setting unit 1003 sets an initial or default language setting. For example, the initial setting is an official or common language of the country where the POS terminal 10 is installed.

The sales registration unit 1004 performs the sales registration for registering the commodities being sold to the customer. For example, the sales registration unit 1004 performs the sales registration with respect to commodities according to a commodity code read as a code symbol by the scanner device 19. In addition, the sales registration unit 1004 performs the sales registration with respect to commodities specified user inputs via the operation control unit 1001.

The display control unit 1005 and the print control unit 1006 are examples of output controlling units that control an output unit such as the first display unit 15, the second display unit 16, and the printing unit 17. The display control unit 1005 operates to display various screens on the first display unit 15 or the second display unit 16 using the language set by the language setting unit 1003. Here, a case in which a sales registration screen on which the sales registration processing of commodities is performed will be described as an example. The display control unit 1005 extracts character string area code (s) from a template image of the sales registration screen that is to be displayed. Then, the display control unit 1005 extracts a character string (for a particular language) corresponding to the extracted character string area code from the character string master 109. In this example, the display control unit 1005 extracts the character string associated with the language code matching the clerk language setting. Then, the display control unit 1005 displays the sales registration screen including the extracted character string on the first display unit 15. In addition, the display control unit 1005 extracts a character string associated with the language code matching the customer language setting. Then, the display control unit 1005 displays the sales registration screen including this extracted character string on the second display unit 16.

When the sales registration unit 1004 performs the sales registration, the display control unit 1005 extracts a commodity name associated with the language code matching the clerk language setting from the commodity master 110. Then, the display control unit 1005 displays the sales registration screen including the extracted commodity name on the first display unit 15. The display control unit 1005 also extracts the commodity name associated with the language code matching the customer language setting from the commodity master 110. Then, the display control unit 1005 displays the sales registration screen including this extracted commodity name on the second display unit 16.

The print control unit 1006 prints (using the printing unit 17) in the language set by the language setting unit 1003. Here, a case where the receipt details the registered commodities of a sales transaction on paper will be described. The print control unit 1006 extracts the character string area code from a template image of a receipt image indicating the details of the sales transaction when the operation control unit 1001 detects a pressing of the current total key 142. The print control unit 1006 extracts the character string associated with the language code of the customer language setting from the character string master 109 with respect to the extracted character string area code. Furthermore, the print control unit 1006 extracts the commodity name associated with the language code of the customer language setting from the commodity master 110 with respect to the commodity on which the sales registration is performed. Then, the print control unit 1006 issues the receipt on which the receipt image including the extracted character string and the extracted commodity name is printed on the paper. The case where the receipt is issued is described. However, the print control unit 1006 is not limited to receipts. For example, when coupons, advertisements, and the like are printed on the printing unit 17 in conjunction with sales transaction, the language used on these other items can be set by the language setting unit 1003 in the same manner as a printed receipt.

When issuing a journal, the print control unit 1006 extracts the character string associated with the clerk language setting from the character string master 109. Furthermore, the print control unit 1006 extracts the commodity name associated with the language code of the customer language setting from the commodity master 110 with respect to the commodity on which the sales registration is performed. Then, the print control unit 1006 issues the journal on which a journal image including the extracted character string and the extracted commodity name is printed on the paper.

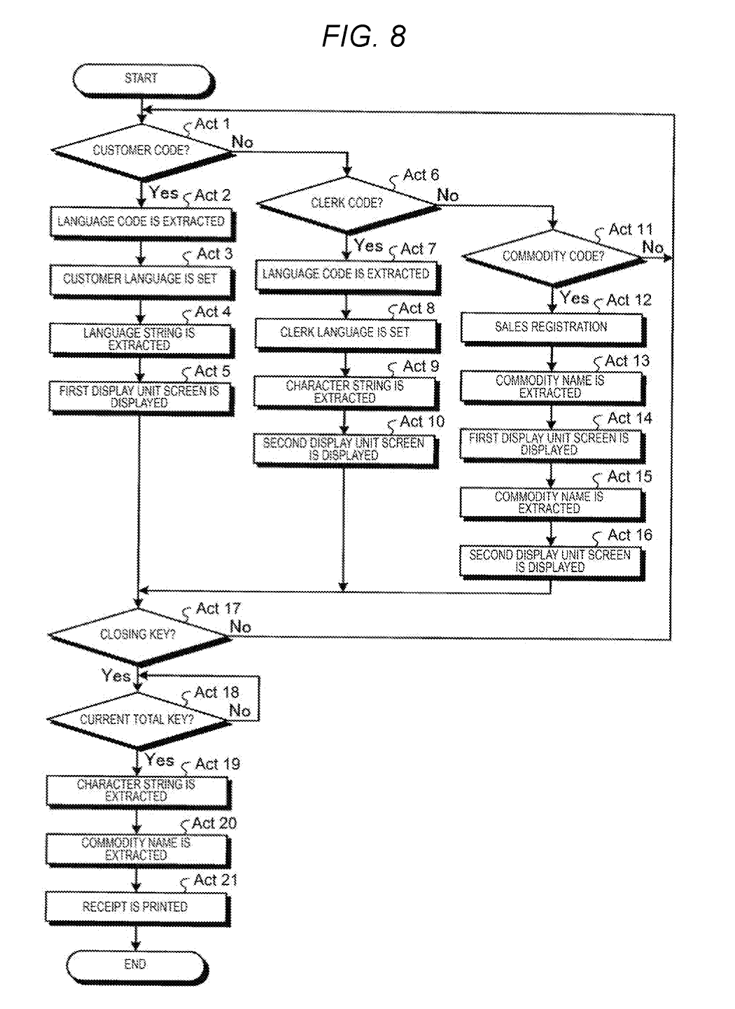

Next, a sales data process performed by the POS terminal 10 will be described. Here, FIG. 8 is a flowchart illustrating an example of the sales data process performed by the POS terminal 10 of the present embodiment.

If a customer code is received (Act 1; Yes), the input control unit 1002 extracts the language code associated with the received customer code from the customer master 108 (Act 2).

The language setting unit 1003 sets the extracted language code in the customer language setting (Act 3). The display control unit 1005 extracts the character string of the language code of the customer language setting from the character string master 109 with respect to the character string area code of a screen being displayed (Act 4).

The display control unit 1005 displays a screen incorporated in the character string area of a screen on which the extracted character string is displayed on the first display unit 15 (Act 5). Then, the process of the POS terminal 10 proceeds to Act 17.

If the customer code is not received (Act 1; No), but the clerk code is received (Act 6; Yes), the input control unit 1002 extracts the language code associated with the received clerk code from the clerk master 107 (Act 7).

The language setting unit 1003 sets the extracted language code in the clerk language setting (Act 8). The display control unit 1005 extracts the character string of the language code of the clerk language setting from the character string master 109 with respect to the character string area code of the screen being displayed (Act 9).

The display control unit 1005 displays an image incorporated in the character string area of the screen on which the extracted character string is displayed on the second display unit 16 (Act 10). Then, the process of the POS terminal 10 proceeds to Act 17.

If the clerk code is not received (Act 6; No) and the commodity code is also not received (Act 11; No), the process of the POS terminal 10 proceeds to Act 1.

If the commodity code is received (Act 11; Yes), the sales registration unit 1004 performs the sales registration according to the received commodity code (Act 12). The display control unit 1005 extracts the commodity name associated with the language code of the clerk language setting from the commodity master 110 (Act 13). The display control unit 1005 displays the extracted commodity name on the sales registration screen of the first display unit 15 (Act 14).

The display control unit 1005 extracts the commodity name associated with the language code of the customer language setting from the commodity master 110 (Act 15). The display control unit 1005 displays the extracted commodity name on the sales registration screen of the second display unit 16 (Act 16).

In Act 17, the operation control unit 1001 determines whether or not the closing key 141 has been pressed (Act 17). If the pressing of the closing key 141 has not been detected (Act 17; No), the process of the POS terminal 10 returns to Act 1.

If the pressing of the closing key 141 is detected (Act 17; Yes), the POS terminal 10 waits until a pressing of the current total key 142 has been detected (Act 18; No).

If the pressing of the current total key 142 is detected (Act 18; Yes), the print control unit 1006 extracts the character string (s) of the language code of the customer language setting from the character string master 109 with respect to the character string area code of an image of the receipt to be printed (Act 19). The print control unit 1006 extracts the commodity name associated with the language code of the customer language setting from the commodity master 110 for the commodity name(s) to be printed on the receipt (Act 20).

The print control unit 1006 prints an image including the extracted character string and the extracted commodity name (Act 21). That is, the print control unit 1006 prints a receipt including the extracted character string and the extracted commodity name.

As described above, the POS terminal 10 completes the sales data process.

As described above, in the POS terminal 10 according to the first embodiment, the input control unit 1002 receives the input for designating the language by the input of the clerk code and the customer code. The language setting unit 1003 selects the designated language to be output on a screen or as a printed matter (e.g., for the output targets of the first display unit 15, the second display unit 16, the printing unit 17, and the like). The display control unit 1005 and the print control unit 1006 output information corresponding to the designated language. Accordingly, the POS terminal 10 can flexibly change the language.

In an embodiment, a case where the sales data processing apparatus is applied to the POS terminal 10 was described as one example. However, the sales data processing apparatus can also be applied to an apparatus other than the POS terminal 10. For example, the sales data processing apparatus can also be applied to a registration apparatus of a semi-self-service checkout system in which the clerk performs the sales registration using the registration apparatus and the customer himself/herself performs a transaction accounting (e.g., payment) process using the accounting apparatus. In addition, the sales data processing apparatus can also be applied to the registration apparatus of a two-person checkout system in which one clerk performs the sales registration on the registration apparatus and another clerk performs the accounting process on the accounting apparatus.

In addition, in one embodiment, it is described that when the clerk code has been read and the customer code has been read, the input control unit 1002 determines that the language code associated with the clerk code and the customer code is to be designated. However, a method for designating the language code is not limited to reading of code information, such as the clerk code and the customer code. For example, the language setting unit 1003 may designate the language code based on a clerk code and a customer code received by the short-range wireless communication, such as near field communication (NFC), infrared light, or Bluetooth®. Alternatively, the language setting unit 1003 may designate the language code upon selection of one language from a screen displaying a plurality of language options.

Furthermore, when one language is selected from a selection screen on which a plurality of the languages has been displayed, the language setting unit 1003 may designate the language code in the clerk language setting and the customer language setting based on the display unit from which the selection input was received. That is, when the touch panel of the first display unit 15 receives the selection input for selecting a language, the language setting unit 1003 sets the language code in the clerk language setting. On the other hand, when the touch panel of the second display unit 16 receives the input for selecting the language, the language setting unit 1003 sets the language code in the customer language setting. When a screen including a button for selecting a language from a plurality of the language options and a button for selecting the application range of the language option is provided, the language setting unit 1003 may set the language code with respect to the clerk language setting and/or the customer language setting according to a combination of the selected buttons.

In addition, in one embodiment, it was described that the print control unit 1006 issues the receipt by printing the receipt image on paper. However, the print control unit 1006 may issue the receipt on paper and/or issue an electronic receipt obtained by digitizing the receipt information. In this case, the POS terminal 10 generates electronic receipt information by converting the receipt image into an electronic receipt format. Then, the POS terminal 10 transmits the electronic receipt information to an information processing device such as a smartphone on which the electronic receipt can be displayed, a server device for managing the electronic receipt system, or the like.

It is assumed that a program to be executed by the apparatuses in the embodiments and the modification examples has been provided by being incorporated in a storage medium (ROM or storage unit) provided in each apparatus. However, the disclosure is not limited thereto. For example, the program may be recorded in a computer-readable recording medium such as a CD-ROM, a flexible disk (FD), a CD-R, a digital versatile disk (DVD), or the like as an installable format file or an executable format file. Furthermore, the storage medium storing the program may be independent from a computer or an embedded system of the apparatuses, and can be a storage medium from which a program transmitted via a LAN, the Internet, or the like can be downloaded and stored, at least temporarily, by the apparatuses.

In addition, the program executed by each of the apparatuses of the embodiments and the modification examples may be configured to be stored on a computer connected to a network such as the Internet, and then provided by being downloaded via the network The program(s) may be configured to be provided or distributed via the network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions

1. A register machine, comprising:
an input device configured to receive an input designating a language selection;
a storage unit storing a character string master table in which character strings corresponding to character string area codes of a pre-established output information template are stored for a plurality of languages; and
a control unit including a processor that is configured to:
select an output target from among a plurality of output devices to which output information related to a sales transaction registered on the register machine can be sent,
set a language of the output information sent to the output target according to the designated language selection, and
output the output information to the output target according to the pre-established output information template for the selected output target, the character strings corresponding to the character string area codes of the pre-established output information template being extracted from the character string master table according to the language that has been set.

2. The register machine according to claim 1, wherein
the input designating the language selection is a customer code, and
the processor is configured to select a display screen oriented to be viewed by a customer in the sales transaction as the output target when the customer code is received by the input device.

3. The register machine according to claim 1, wherein
the input designating the language selection is a clerk code, and
the processor is configured to select a display screen oriented to be viewed by a sales clerk in the sales transaction as the output target when the clerk code is received by the input device.

4. The register machine according to claim 1, further comprising:
a printer configured to print output information on paper, wherein
the controller unit is configured to select the printer as the output target upon completion of the sales transaction and output information is printed in the language that has been set.

5. The register machine according to claim 4, wherein the language printed by the printer is set according to a customer code received by the input device.

6. The register machine according to claim 1, further comprising:
a first display oriented to be viewed by a customer in the sales transaction;
a second display oriented to be viewed by a sales clerk in the sales transaction;
a keyboard by which the sales clerk can input information related to the sales transaction;
a bar code reader device for reading bar codes on items related to the sales transaction; and
a printer configured to print output information on paper, wherein
the input device includes a first touch screen on the first display, a second touch screen on the second display, the keyboard, and the bar code reader.

7. The register machine according to claim 6, wherein the plurality of output devices includes the first display, the second display, and the printer.

8. The register machine according to claim 7, wherein:
the storage unit further stores:
a clerk master table in which clerk codes are associated with a clerk language preference,
a customer master table in which customer numbers are associated with a customer language preference, and
a commodity master table in which names for items in the sales transaction are stored for the plurality of languages.

9. The register machine according to claim 1, wherein:
the storage unit further stores:
a clerk master table in which clerk codes are associated with a clerk language preference,
a customer master table in which customer numbers are associated with a customer language preference, and
a commodity master table in which names for items in the sales transaction are stored for the plurality of languages.

10. The register machine according to claim 9, further comprising:
a communication interface, wherein
the storage unit is in a store server in communication with the communication interface.

11. A point of sale terminal, comprising:
a register machine according to claim 1;
a keyboard connected to the register machine;
a first display screen oriented to be viewed by a customer in the sales transaction;
a second display screen oriented to be viewed by a sales clerk in the sales transaction; and
a drawer for storing cash related to the sales transaction.

12. A point-of-sale processing method of a register machine, comprising:
receiving an input for designating a language selection via an input device;
registering an item in a sales transaction using a scanner device;
selecting an output target from among a plurality of output devices to which output information related to the sales transaction can be sent;
setting a language of the output information sent to the output target according to the designated language selection; and
outputting the output information to the output target according to a pre-established output information template having data fields corresponding to character string area codes, the data fields corresponding to aspects of the sales transaction and being populated with information related to the sales transaction by the character string area codes being replaced by character strings extracted from a character string master table in which the character strings are stored in correspondence to the character string area codes for a plurality of languages, the extracted character strings being in the language that has been set.

13. The sales data processing method according to claim 12, wherein the input for designating the language selection is a customer code corresponding to a customer in the sales transaction.

14. The sales data processing method according to claim 12, wherein the input for designating the language selection is a clerk code corresponding to a sales clerk in the sales transaction.

15. The sales data processing method according to claim 12, wherein the pre-established output template is selected according to the selected output target.

16.-20. (canceled)
